(19) United States
(12) Patent Application Publication
(10) Pub. No.: US 2011/0129785 A1
(43) Pub. Date: Jun. 2, 2011

(54) Orthodontic device

(76) Inventors: Morton Cohen, Elkins Park, PA (US); Aaron Cohen, Lake Worth, FL (US); Elliott Silverman, Linwood, NJ (US)

(21) Appl. No.: 12/658,755

(22) Filed: Feb. 9, 2010

Related U.S. Application Data
(63) Continuation-in-part of application No. 61/207,258, filed on Feb. 10, 2009.
Application No. 61/207,258 is a continuation-in-part of application No. 61/260,082, filed on Nov. 11, 2009.

(51) Int. Cl. A61C 7/00; A61C 7/14

(52) U.S. Cl. 433/8; 433/18

(57) ABSTRACT

An improved orthodontic tensioning device having an elastomeric resilient body portion and first and second connectors which are securely attached to the elastomeric resilient body portion and have elements for connecting with a connecting structure.

The orthodontic tensioning device preferably is applied by the orthodontist thus eliminating any dependency on the patient to faithfully wear his elastics. This provides control by the dental professional, and generally may improve results by reducing or eliminating tendencies of those who fail to replace or use elastics. It's all controlled by the dentist!

### CROSS-REFERENCE TO RELATED APPLICATIONS

This application is a continuation-in-part of, and claims priority to, U.S. patent application Ser. No. 61/207,258 filed on Feb. 10, 2009, and U.S. patent application Ser. No. 61/260,082 filed on Nov. 11, 2009, the disclosures of which are incorporated herein by reference.

### BACKGROUND OF THE INVENTION

1. Field of the Invention

The present invention relates to orthodontic devices, and more particularly to orthodontic tensioning devices.

2. Brief Description of the Related Art

Orthodontic treatment began years ago, one of the most notable developments coming from Edward Angle, who in the early 1900's classified certain malocclusions into three categories, malocclusions being the relationship with the molars and the upper and lower teeth to each other. A class I malocclusion, by definition, is when the upper first molar has its mesio-buccal cusp in the groove, the buccal groove of the lower first molar. That is a class I definition of the relationships of the molars. If the molars are in that position, all the other teeth in the arches, upper and lower, may be crowded, and there may also be an overlapping of teeth. So it was this relationship that was defined as a class I malocclusion.

The second category, class II malocclusions is where the mesio-buccal cusp of the upper first molar is not in that lower buccal groove of the first molar, but is one half step forward. All the other teeth, therefore, are forward, and, therefore, the upper front teeth are correspondingly forward. The class II malocclusion also involved the fact that the lower jaw in 25% of these malocclusions really was at fault because it was retrusive or recessive, so that really brought not the upper teeth forward, but it in essence the lower jaw brought all the lower teeth backward. So that created the same situation with the molar relationships, which is called class II. Generally, the class II malocclusion is characterized by the lower dental arch being located excessively rearward relative to the direction of the upper dental arch when the jaws are closed.

A class III malocclusion is where the lower molar and all the teeth anterior, or forward of the lower molar, generally are forward of the upper mesial cusp of the first molar. It is the reverse situation to that of class II. The class III malocclusion is where the lower dental arch is located forwardly from its location relative to the position of the upper dental arch when the jaws are closed.

Treatment of class II and class III malocclusions generally involves the movement of the teeth to orthodontically correct positions. Edward Angle was awarded U.S. Pat. No. 678,453 for a rigid archwire attached to teeth to draw the teeth together. Orthodontists utilize orthodontic appliances, which may, for example, include brackets, buccal tubes, archwires, and other items which are attached to the teeth. Brackets generally have a slot to hold the archwire, and buccal tubes, which are generally attached to the patient's molars, retain the ends of the wire. For example, the archwire may span from a buccal tube attached to a molar, and continue medially to the midline through the brackets attached to each of the teeth of the dental arch, and from the midline, distally to the other end of the dental arch where the archwire is secured to a buccal tube. It is generally common to refer to such orthodontic appliances of the type mentioned collectively, as braces.

Also used in conjunction with the brackets and wires are elastomeric tensioning elements. Rubber or elastic bands have been customarily used in the field of orthodontics to provide a force application to the teeth and jaws in connection with wires and brackets. Generally, the elastomeric bands are used in pairs and are connected between the upper and lower dental arches to the respective braces. The elastomeric bands generally facilitate the application of a directional force to move the teeth over time to their desired positions. The elastomeric bands are sometimes referred to as intraoral bands, and may, for example, be connected within the patient's mouth at one end over a hook on a cuspid bracket supporting an upper archwire, and at the other end to a hook on a molar tube supporting a lower archwire. There may be a band and a molar tube and hook applied on the opposite side of the dental arch in the same manner. Patients are required to remove and replace the intraoral bands frequently in order to facilitate and maximize the directional force being applied. If the patient complies, and replaces the bands (e.g., once a day), as instructed, then the tension is maximized and the treatment time is minimized. A person is supposed to put an elastic on the hook on the front or the anterior and stretch it to the hook on the molar, either upper or lower, depending on whether the patient is being treated for a class II malocclusion or a class III malocclusion. However, a problem is that the use of the elastomeric bands has been voluntary and often, many patients fail to wear their elastomeric bands, or fail to change them, or both, as instructed. Therefore, cases where treatment takes perhaps two years to complete, may have been completed in one year, had the patient worn the elastomeric bands consistently, as instructed.

Prior attempts to address the situation involve the use of a mechanism which is placed on the wires and on the teeth so that the patient cannot take it off, and then, the result presumes that the patient's treatment moves along much more quickly. One prior mechanism is generally referred to as the Herbst appliance, and another is the Forsus appliance. These mechanisms are constructed having an outside cylinder and, inside the cylinder, is a compressible coil spring which, once compressed, wants to open, which is the driving force. One type of Herbst appliance has a telescoping rod and sleeve assembly for its force transmission member.

Other attempts have been made incorporating springs for force transmission. One example is U.S. Pat. No. 4,708,646 issued on Nov. 24, 1987 to James J. Jasper for an “Orthodontic Device for Correcting the Bite” which discloses a spring with caps that are provided to slide along a wire. U.S. Pat. No. 5,352,116 issued on Oct. 4, 1994 to Richard P. West for an “Adjustable Bite Corrector” which shows the use of a coil spring in an adjustable length device for applying a force. While these devices have attempted to provide a way to ensure that the patient wears the device, these devices are not without their own problems. For example, when the spring is covered by an outer sheath, the breaking of the spring, which may from time to time occur, may be masked.

Another coil spring is shown in U.S. Pat. No. 5,545,037 issued on Aug. 13, 1996 to Watanabe Takeshi for an “Interarch Orthodontic Coil Spring”. U.S. Pat. No. 5,651,672 issued on Jul. 29, 1997 to James D. Cleary et al. discloses an “Orthodontic Force Module” which refers to an elongated body made of an elastomeric material with couplings at each end for connection to selected orthodontic appliances. U.S. Pat. No. 5,897,313 issued on Apr. 27, 1999 to James D. Cleary et al. also discloses an “Orthodontic Force Module”; and U.S. Pat. No. 6,053,730 issued on Apr. 25, 2000 to James D. Cleary discloses an “Orthodontic Force Module With Fracture Resistant Coupling”. U.S. Pat. No. 6,120,289 issued on Sep. 19, 2000 to James D. Cleary et al. for an “Orthodontic Attachment Device for Interarch Appliances”, discloses a wire segment which permits the orthodontic device to move more freely. These devices have been proposed to provide a device which is not removable in order to attempt to alleviate the problems of the patient failing to replace or use traditional bands in the manner recommended by the orthodontist.

A need exists for an orthodontic device which provides the application of force to orthodontic appliances, such as, for example the brackets, buccal tubes, archwires, or attachments connected to the archwires, brackets, or tubes, and which facilitates consistent use of the device by the patient.

### SUMMARY OF THE INVENTION

The present invention provides an improved orthodontic device for applying a directional force to facilitate the correction of the alignment of teeth. The device is provided for use in conjunction with orthodontic appliances, including with orthodontic members, such as, for example, brackets, tubes, hooks and wires, and orthodontic members attached thereto. The device is particularly useful in conjunction with orthodontic interarch appliances and intraarch devices. The orthodontic device of the present invention may be used intraorally to apply tension between an upper orthodontic appliance and a lower orthodontic appliance. For example, the orthodontic device of the present invention may provide tensioning between an upper interarch wire and a lower interarch wire. The present orthodontic device may be connected to hardware structures, such as, for example, hooks, brackets or other structures which are applied to, or carried on, the teeth. The orthodontic device may be used, for example, intraorally by attaching one end of the device to a hook on a cuspid bracket supporting an upper archwire, and attaching the other end of the orthodontic device to a hook on a molar tube supporting a to lower archwire. The device has an elastomeric component and connectors for connecting the device to an orthodontic appliance. In a preferred form, the device, in accordance with the invention, may be connected at each end thereof to an orthodontic appliance, such as, for example, on a hook of a bracket, or wire.

It is an object of the present invention to provide a novel orthodontic device for applying a directional force to teeth to facilitate correction of an orthodontic condition or problem.

It is a further object of the present invention to provide an orthodontic device which may be attached to an orthodontic appliance to facilitate tensioning teeth.

It is a further object of the present invention to provide an orthodontic device which facilitates orthodontic treatment by minimizing the treatment time for a patient.

It is a further object of the present invention to facilitate the minimizing of the treatment time by providing a device which requires no effort on the part of the patient to use in that the device may be installed during an orthodontic visit, as opposed to repeated reinstalls at home by the patient.

It is another object of the present invention to provide an elastomeric interarch device which may be attached to orthodontic appliances by crimping.

### BRIEF DESCRIPTION OF THE PREFERRED EMBODIMENTS

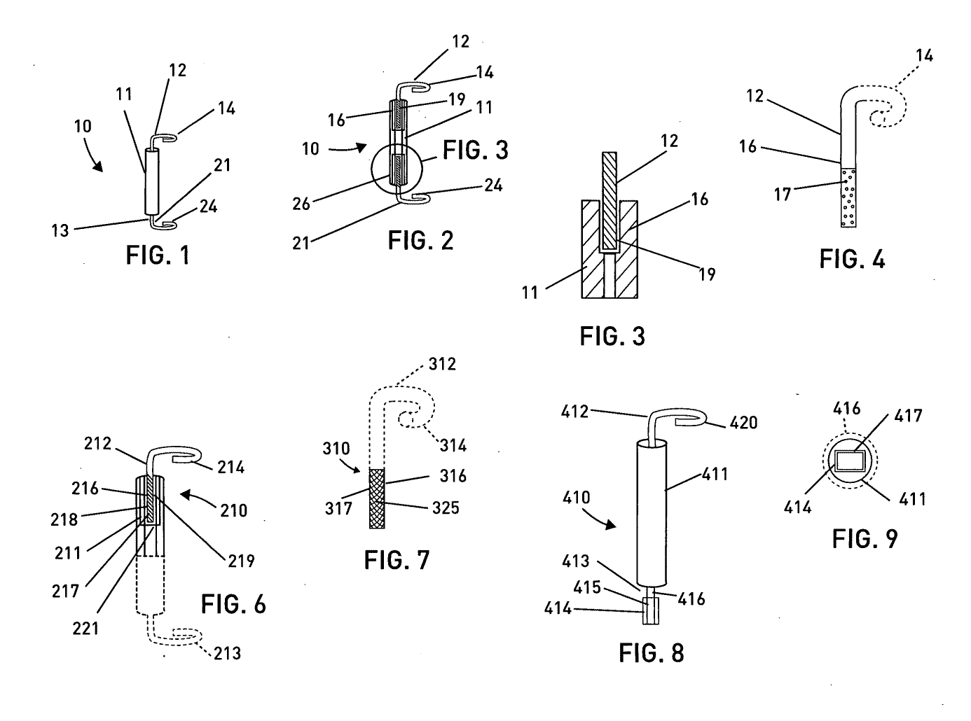

FIG. 1 is a front elevation view of an orthodontic tensioning device according to the present invention.

FIG. 2 is a sectional view of the device of FIG. 1.

FIG. 3 is a partial sectional view taken in the area 3 of FIG. 2.

FIG. 4 is an enlarged partial view of a first alternate embodiment of the leg portion of the first connector.

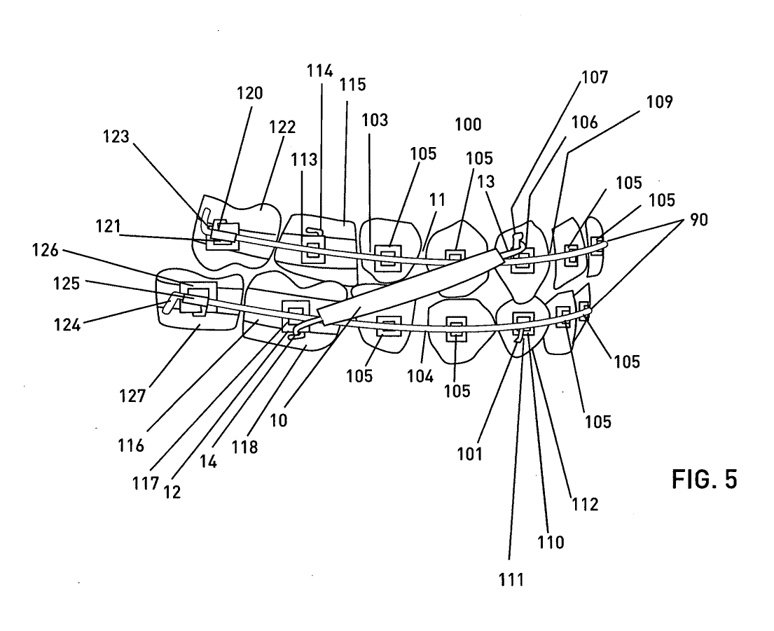

FIG. 5 is a view of the tensioning device of FIG. 1 installed on an orthodontic appliance mounted to a patient's teeth.

FIG. 6 is a sectional view of a second alternate embodiment of an orthodontic tensioning device according to the present invention, showing the first connector and a partial view of the elastomeric body portion.

FIG. 7 is an enlarged partial view of a third alternate embodiment of the leg portion of the first connector.

FIG. 8 is an elevation view of a fourth alternate embodiment of an orthodontic tensioning device according to the present invention, illustrated with a split tube connector.

FIG. 9 is a bottom plan view of the device of FIG. 8.

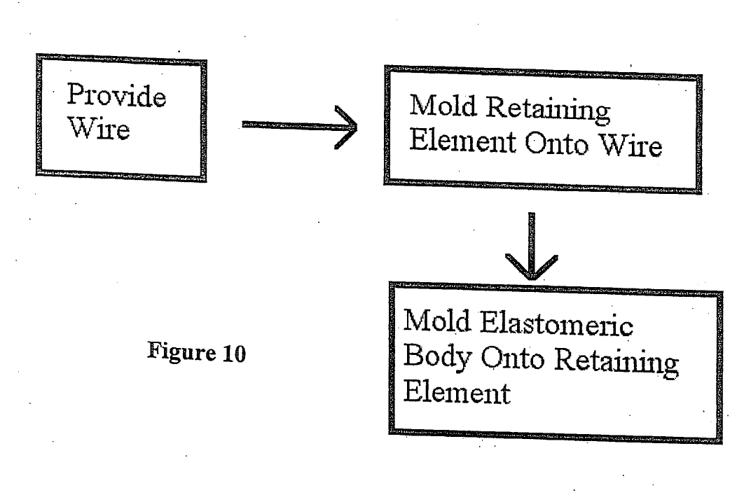

FIG. 10 is a schematic illustration of a method for producing a tensioning device according to the invention.

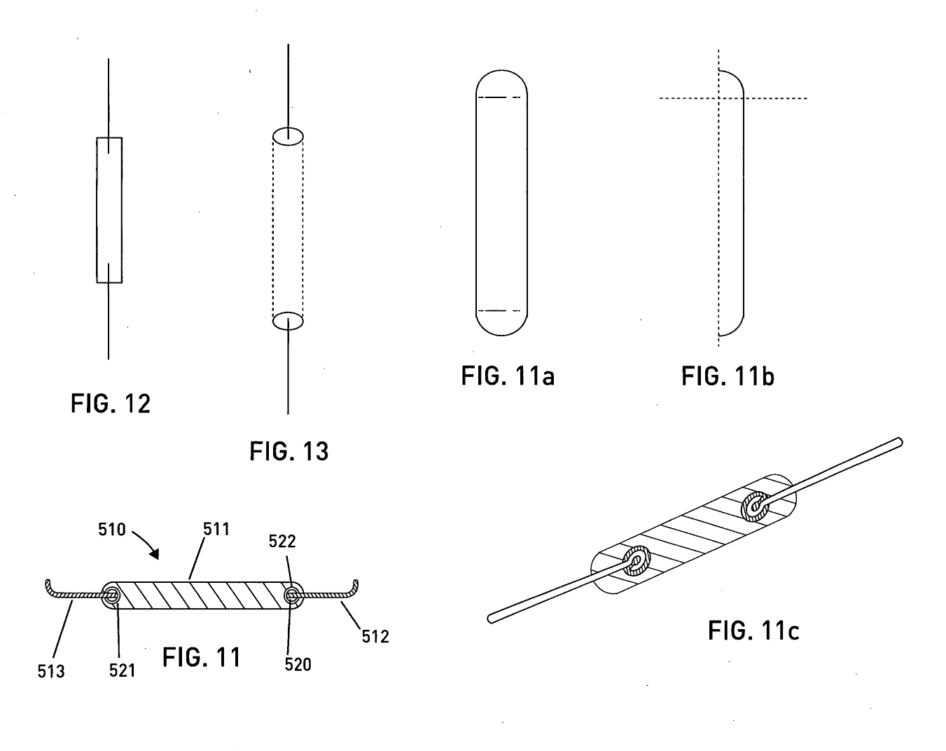

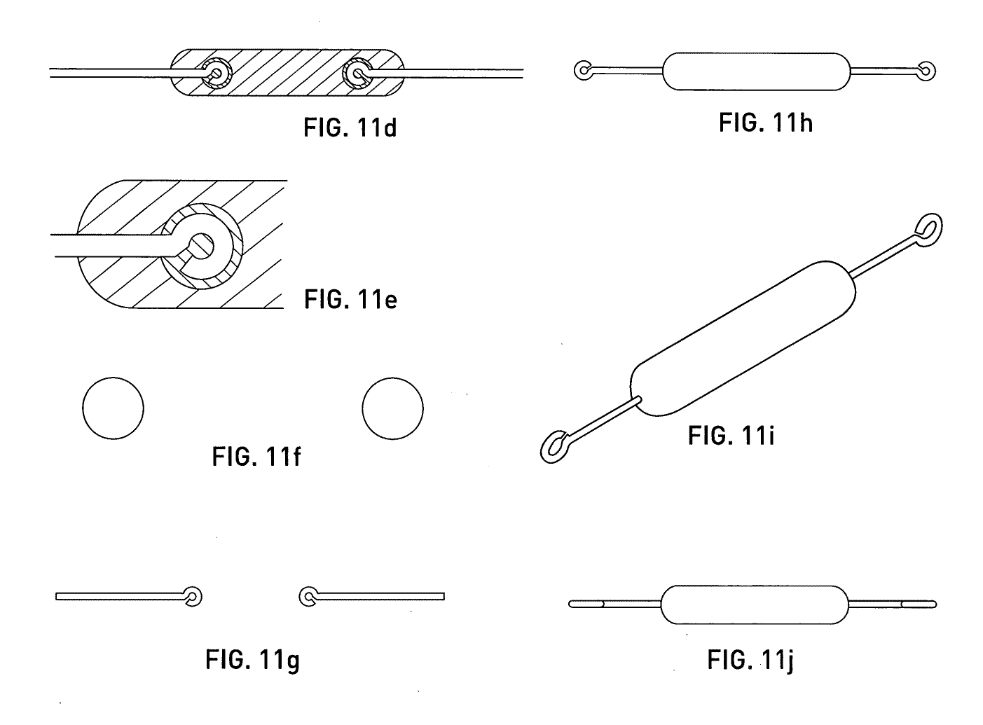

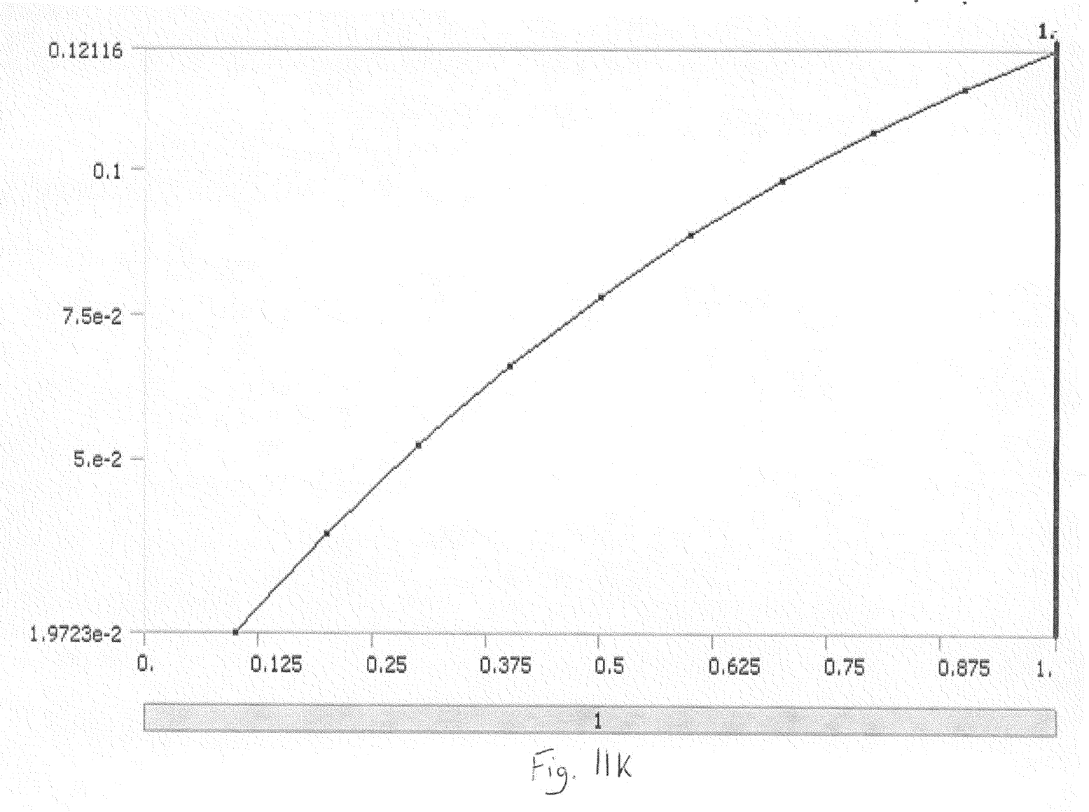

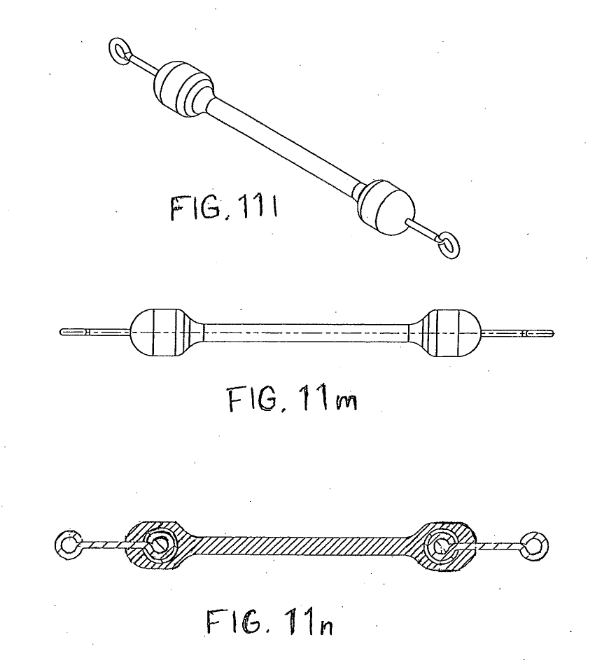

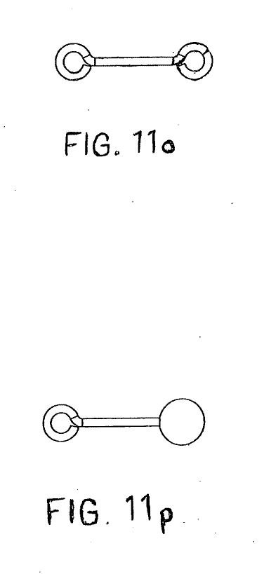

FIG. 11 is a sectional view of a fifth alternate embodiment of an orthodontic tensioning device according to the invention.

FIGS. 11a through 11g illustrate alternate configurations of the fifth alternate embodiment shown in FIG. 11.

FIGS. 11h through 11j illustrate alternate configurations of the fifth alternate embodiment shown in FIG. 11, but having a closed end loop configuration.

FIG. 11k is a graph of a plot of force (in psi) on the y-axis versus time (in seconds) on the x-axis for an exemplary proposed stretching profile of the embodiment illustrated in FIGS. 11a through 11g.

FIGS. 11l through 11p illustrate alternate configurations of the fifth alternate embodiment shown in FIG. 11.

FIG. 12 is a front elevation view of a tensioning device according to the present invention.

FIG. 13 illustrates a schematic embodiment of a partial view of a device according to the present invention showing the wire member and the retaining element in separate view.

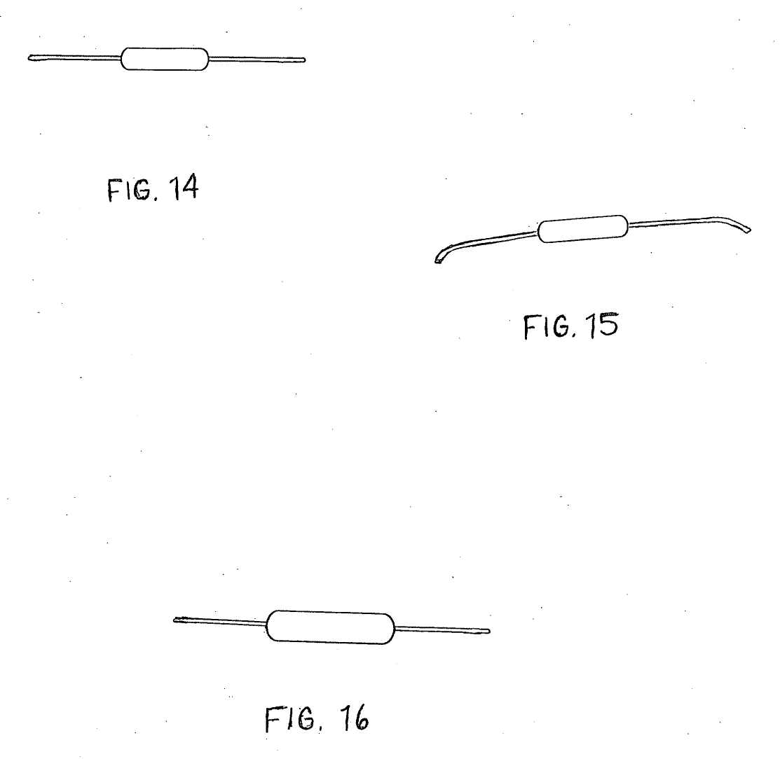

FIGS. 14-16 illustrate examples of embodiments of orthodontic tensioning devices according to the invention.

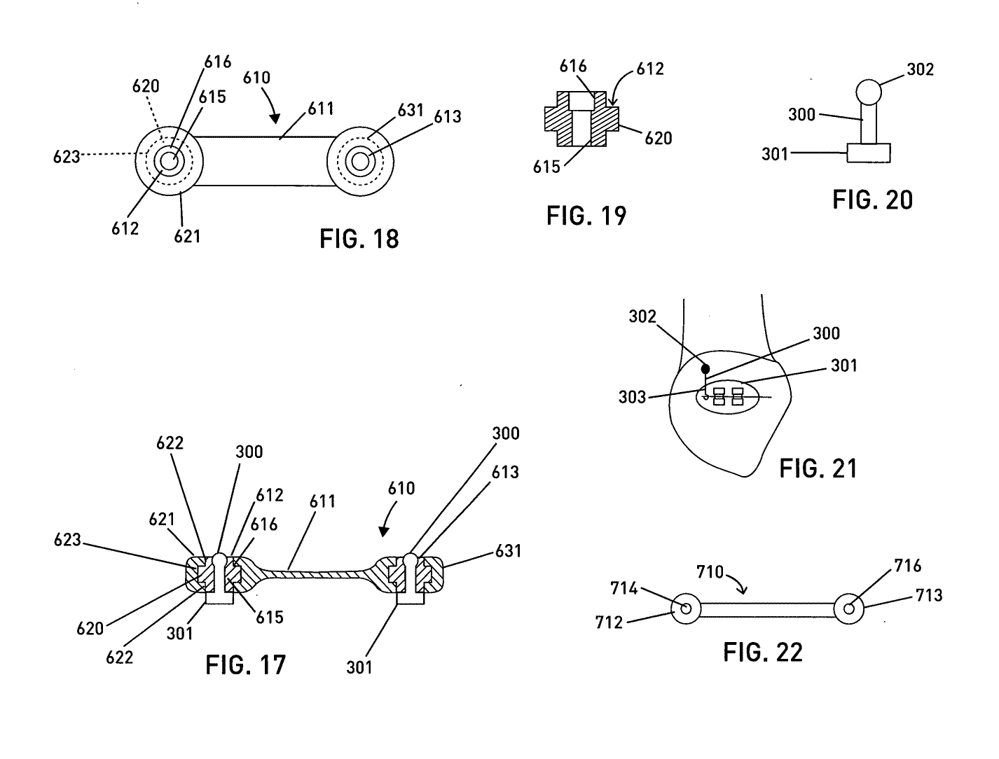

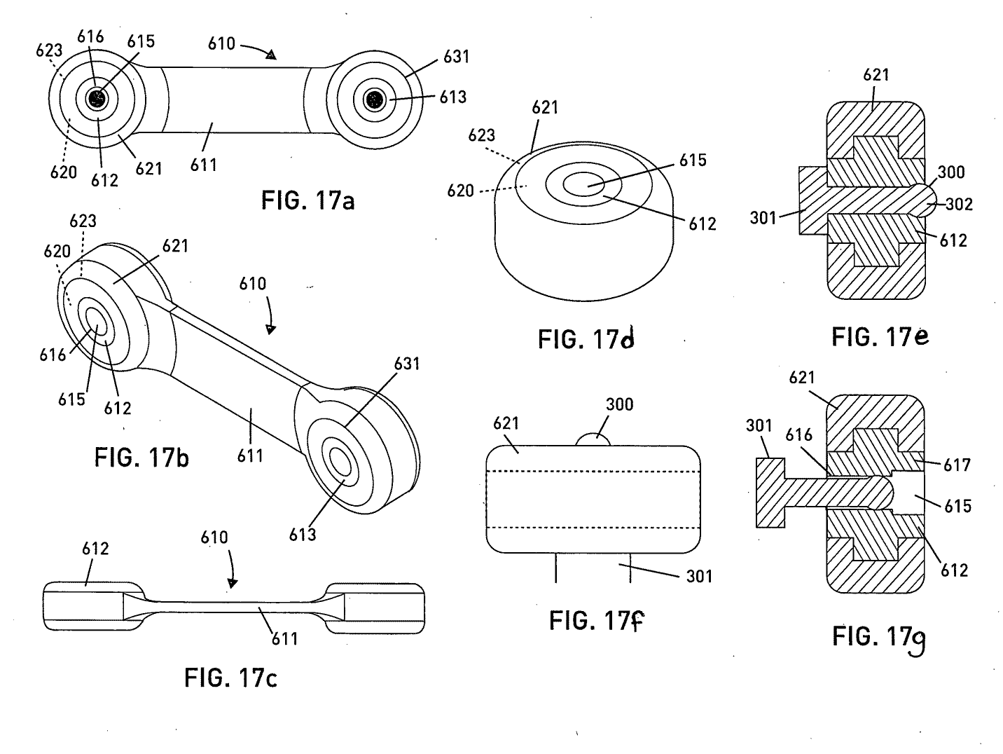

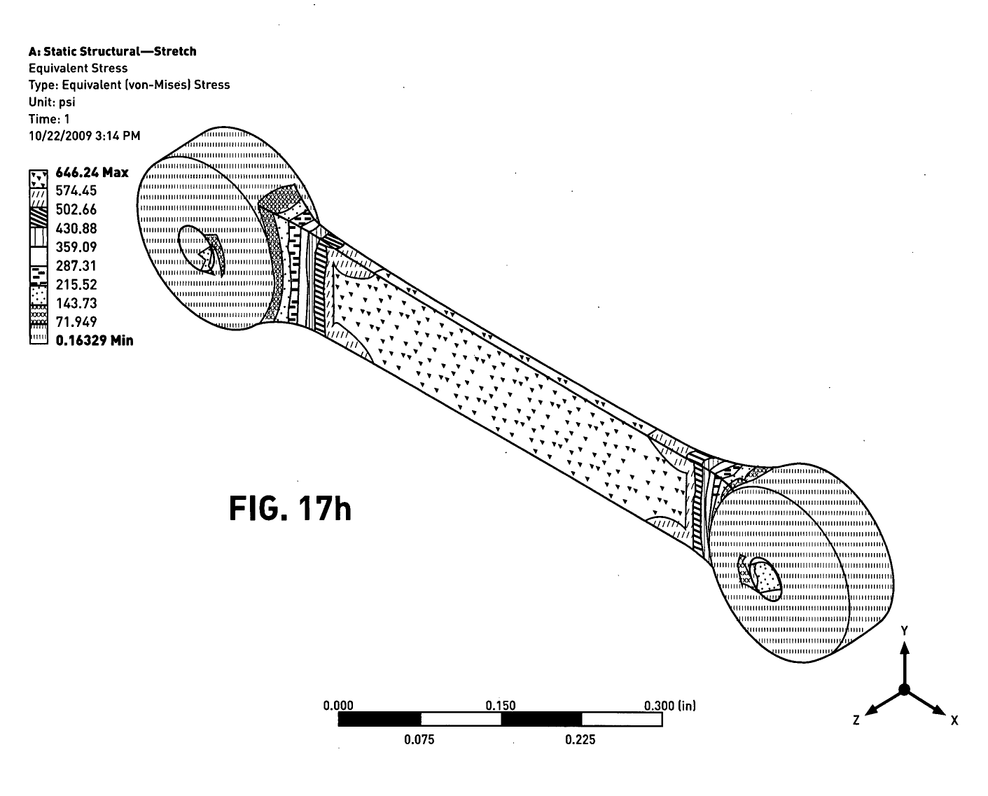

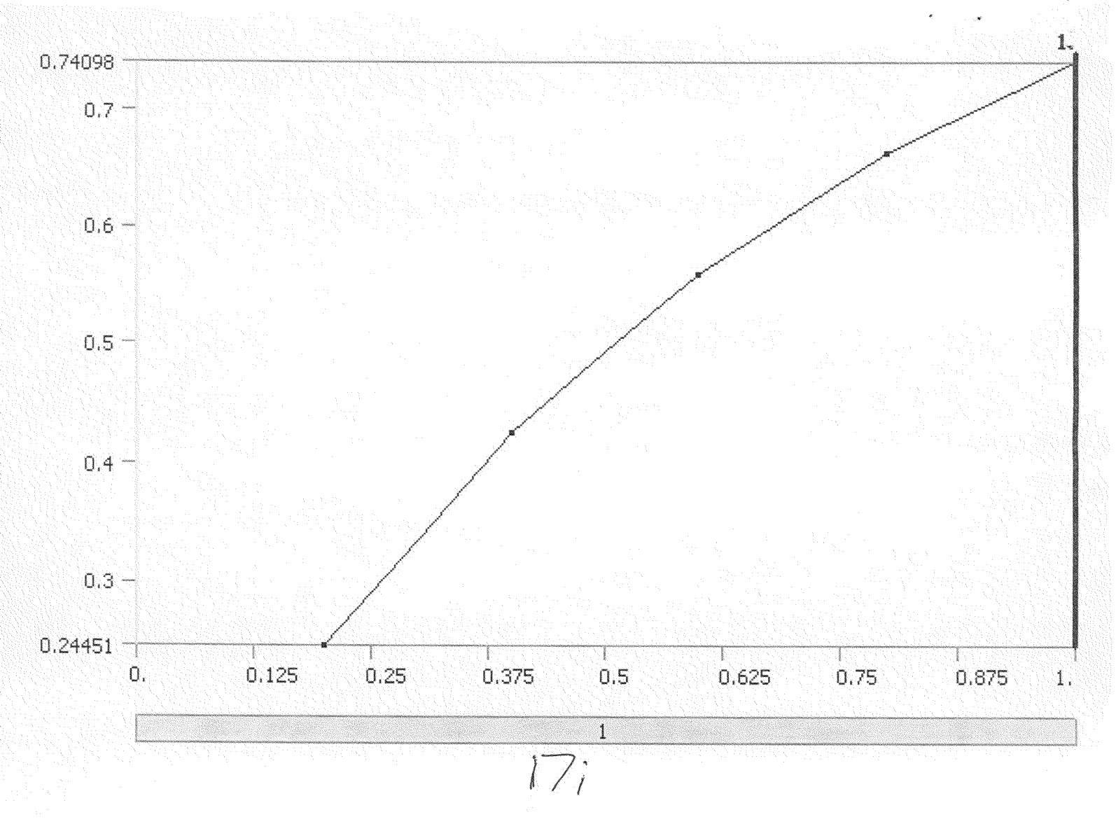

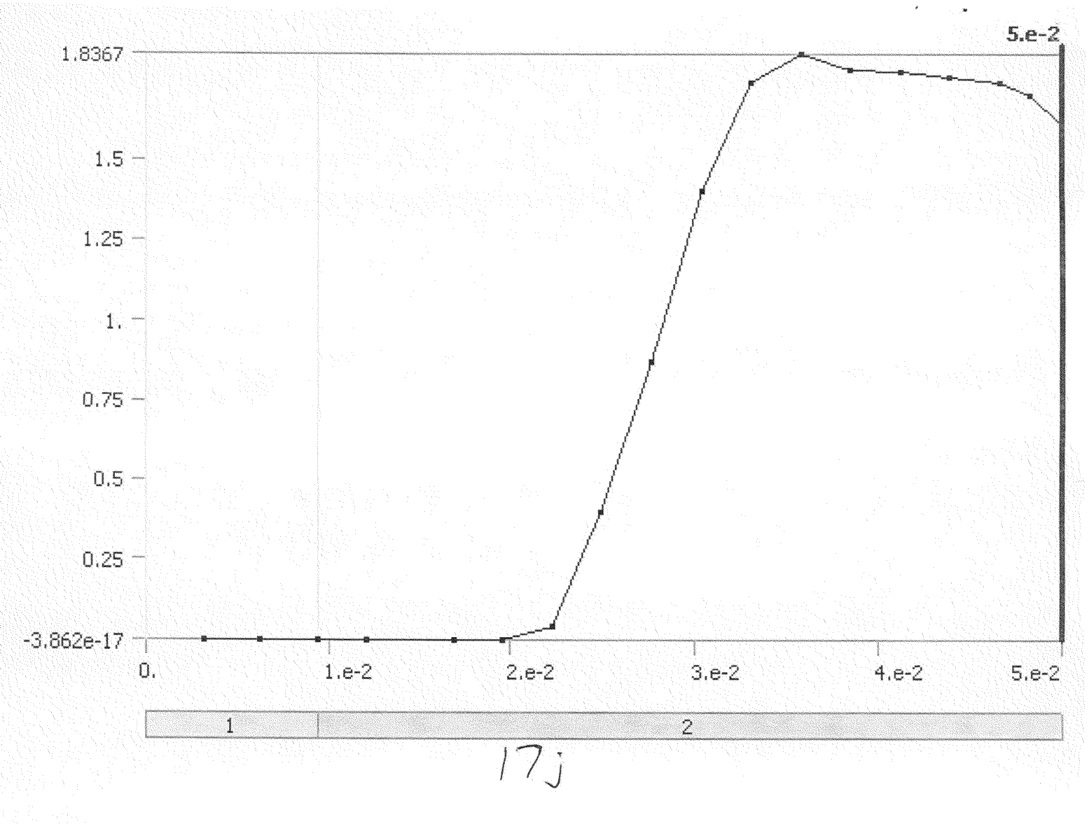

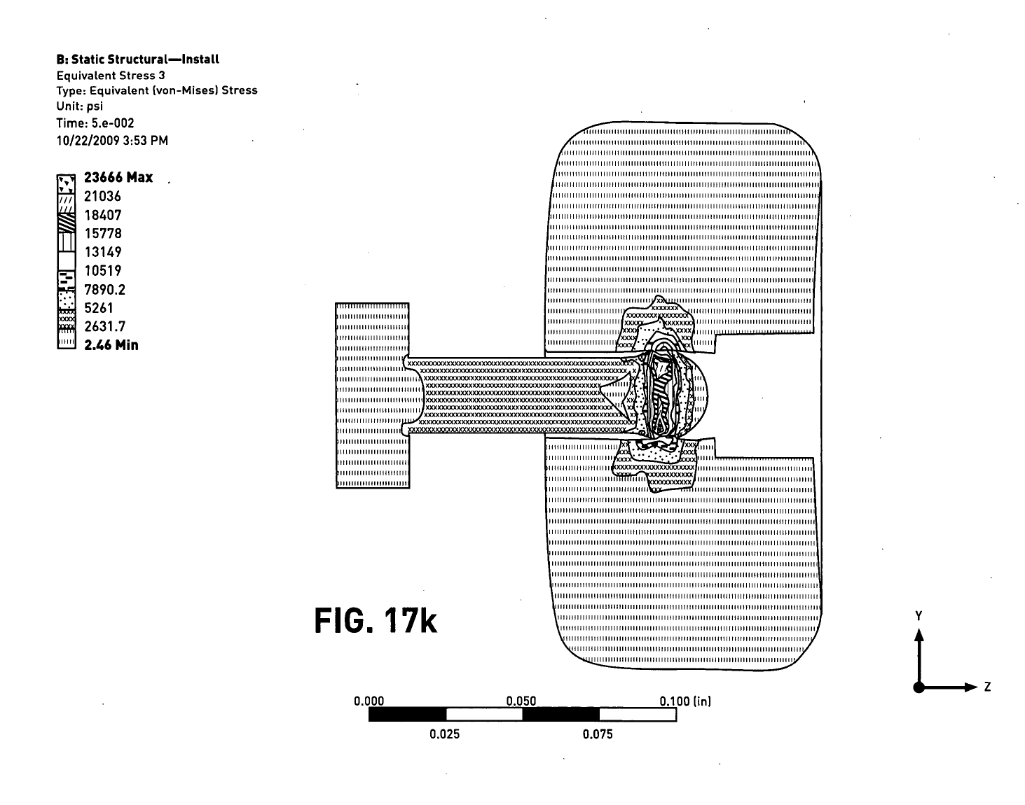

FIG. 17 is a sectional view of an alternate embodiment of an orthodontic tensioning device shown in an exemplary environment where the device is installed on the pins of brackets.

FIGS. 17a through 17g are alternate illustrations of the alternate embodiment of the tensioning device shown in FIG. 17.

FIG. 17i is a graph of a plot of force (in psi) on the y-axis versus time (in seconds) on the x-axis for an exemplary proposed stretching profile of the embodiment illustrated in FIGS. 17a through 17g, where FIG. 17h is shown with corresponding force profile data.

FIG. 17j is a graph of a plot of force (in psi) on the y-axis versus time (in seconds) on the x-axis for an exemplary proposed stretching profile of the engaging end of the embodiment illustrated in FIGS. 17a through 17g, where FIG. 17k is shown with corresponding force profile data.

FIG. 18 is a top plan view of the device of FIG. 17, shown separate from the bracket and pins.

FIG. 19 is a sectional view of the retaining element of the device of FIG. 17, shown separate from the other components.

FIG. 20 is a separate view of an example of a bracket with a pin that the device of FIG. 17 may be used in connection with.

FIGS. 21-24 illustrate an alternate embodiment of an orthodontic tensioning device constructed with a grommet at the ends for connecting to an orthodontic structure, such as a hook using a split washer retainer.

FIGS. 25-28 show an alternate embodiment of a tensioning device with a retaining cap attachment mechanism.

FIG. 29 shows an alternative embodiment of an orthodontic tensioning device with a linkage attachment mechanism.

### DETAILED DESCRIPTION OF THE PREFERRED EMBODIMENTS

Preferred embodiments are disclosed in the drawing figures and described herein. The orthodontic devices are constructed with an elastomeric component that exhibits resiliency when stretched and provides a force that encourages the return of the component from its stretched condition to its unstretched condition. In use, the tensioning devices of the invention may be installed in an orthodontic application where the tensioning device is stretched from a slightly stretched condition or from an unstretched condition. The activity of the patient's muscle movement, for example, when opening and closing one's mouth or jaw, may cause a tensioning device that is installed on orthodontic hardware in the patient's mouth to stretch and release the tension that the elastomeric component provides.

Referring to FIGS. 1-3, there is illustrated an orthodontic device 10 having a resilient body portion 11 with a first connector 12 and a second connector 13. The resilient body portion 11 preferably carries the first connector 12 at one end thereof and the second connector 13 at the other end thereof. The first connector 12 is mounted to the resilient body portion 11 and has means for attaching the first connector 12 to an orthodontic appliance. The second connector 13 is mounted to the resilient body portion 11 and has means for attaching the second connector 13 to an orthodontic appliance. Preferably, the resilient body portion 11 is comprised of a material which is not readily prone to corrosion when exposed to the environment of a patient's mouth. The resilient body portion 11 may be comprised of other orally suitable elastomers, such as natural and synthetic rubbers, thermoplastic elastomers, and blends of these materials. Preferred materials include those selected from the group of materials including: SBC's (styrene-block-copolymers), such as, SEBS (styrene ethylbutylene styrene), SEPS (styrene ethylene propylene styrene), SBS (styrene butadiene styrene), SIS (styrene isoprene styrene), and EPDM (ethylene-propylene-diene-monomer), thermoplastic polyurethane, cross linked polyurethane, silicone, natural rubber, and copolyester. As illustrated in FIGS. 1-3, the device 10 is shown having a resilient body portion 11 which comprises an elastomeric tube.

In a first preferred embodiment, the first connector 12 comprises a crimpable metal material, and is configured having securing means for securing the first connector 12 to an orthodontic appliance. Preferably, as shown in FIG. 1, the connecting means may comprise a hook 14. The orthodontic appliance, to which the first connector 12 may be secured, for example, may be a hook of a bracket, an archwire, or other orthodontic appliance or part thereof. Mounting means is provided for mounting the first connector 12 to the body portion 11. The mounting means is shown in the first preferred embodiment device 10 comprising a mounting leg 16 which mounts the first connector 12 to the body portion 11. The mounting leg 16 preferably is disposed within the resilient body portion 11, and preferably has holding means 18 to facilitate retention of the first connecting element 12 on the body portion 11. The hook 14 is configured for connection to a connecting structure, such as, for example, an archwire, bracket, hook or other orthodontic appliance. The first connector hook 14 preferably is comprised of a crimpable material to facilitate connection of the first connector 12 to another structure. As illustrated in FIG. 5, the connecting structure is shown comprising a receiving hook 21 of an archwire 22. The first connector 12 is placed on the receiving hook 21 by positioning the hook 14 of the first connector 12 over the receiving hook 21, and when the aperture 14 is positioned on the receiving hook 21, a force is applied to the hook 14 to crimp it in attaching engagement with the receiving hook 21.

The second connector 13 of the device 10 may then be connected to another archwire, bracket, hook or other orthodontic appliance. In the illustration shown in FIG. 1, the second connector 13 of the device 10 of the first embodiment preferably may be the same as the first connector 12, but is attached at the opposite end of the body portion 11. The second connector 13 is shown having a hook 24 for securing the second connector 13 to an orthodontic appliance. The hook 24 of second connector 13 preferably is comprised of a crimpable material. Mounting means is provided for mounting the second connector 13 to the body portion 11, and preferably may comprise a mounting leg 26 which mounts the second connector 13 to the body portion 11. The mounting leg 26 preferably is disposed in the resilient body portion 11, with adhesive as described herein, and preferably has raised bumps 27 to facilitate retention of the second connector 13 on the body portion 11.

Referring to FIG. 5, the device 10 is shown illustrating an example of the application of a crimping force to the first connector 12. The hook 14 is shown in a crimped condition. The crimping may take place with the use of pliers or other force applying tool to apply force to hook 14 to reshape the hook 14 for engagement with an orthodontic structure to which the device 10 is to be attached. Preferably this is accomplished by closing the hook 14. The crimping of the first connector 12 facilitates the securing of the connector 12 to an orthodontic appliance. Preferably, the second connector 13 is also secured to an orthodontic appliance, and may be done in the same manner, by crimping the hook 24.

In FIG. 5, the device 10 is shown installed on an orthodontic appliance 90, such as, for example, an upper appliance 100 and lower appliance 101. In FIG. 5, the right side of the patient's teeth is shown, and generally, although not shown, the left side may be similar with the appliances being installed on the teeth in the same manner. In the example illustrated in FIG. 5, the appliance 90 is what has been generally referred to as braces, which, in this example, includes an upper archwire 103, a lower archwire 104, and a plurality of brackets 105 affixed to a patient's teeth. The brackets 105 may be attached to the teeth with a suitable adhesive. The bracket 106 is shown having a post 107 attached thereto, and is attached to an upper canine tooth 109. A bracket 110 is shown having a post 111 attached thereto and mounted on a lower canine tooth 112. A bracket 113 with a hook 114 is attached to an upper molar 115. A lower molar band 116 with a receiving hook 117 is attached to a lower molar 118. A band 120 with a tube 121 is provided on the upper molar 122 at the distal end of the upper dental arch. The upper archwire 103 is secured at the tube 121 on the upper molar 122, and is bent to form an end 123 which retains the archwire 103. The upper archwire 103 is shown spanning the brackets attached to the upper teeth. Similarly, the lower archwire 104 has an end 124 which is secured at the tube 125 (which may include a hook) which is carried by a band 126 attached to the lower molar 127 at the distal end of the lower dental arch. In the illustration shown in FIG. 6, the orthodontic appliance components are being applied to a patient's teeth to correct a class II malocclusion. The device 10 is positioned on the orthodontic appliance 90. As illustrated, the first connector 12 of the device 10 is positioned on the hook 117 of the lower molar band 116. The hook 14 is positioned on the receiving hook 117 and is received on the hook shaft 130. The hook 14 preferably is crimped or closed to remain secured on the receiving hook 117 (which also may be crimped or locked). The device 10 is then stretched to position the second connector 13 on the post 107 of the bracket 106 on the upper canine 109. When installed on the orthodontic appliance 90, the device 10 supplies a force to the upper and lower archwires, respectively 103 and 104, to facilitate the treatment which is designed to bring the teeth to an orthodontically desired alignment.

The device 10 may be attached to the orthodontic appliance 90 by crimping the first connector 12 and the second connector 13 to secure the device 10 to the respective points of connection on the orthodontic appliance. As shown in FIG. 5, the hook 14 of the first connector 12 is crimped for securing engagement with the receiving hook 117. The hook 24 of the second connector 13 is crimped for securing engagement with the post 107. The hook 117 and post 107 are provided for illustration, and the orthodontic appliance may have other components by which the device 10 may connect to provide a force to the patient's jaw or teeth being treated. For example the device 10 may be connected to a wire, tube, or other component.

In a second preferred embodiment illustrated in FIG. 6, the device 210 is shown having a resilient body portion 211 and a first connector 212 with a leg 216 and a hook 214. The leg 216 is illustrated with holding means comprising a loop 217. The leg 216 has a first leg portion 218 which is spaced from a second leg portion 219, to define a loop 217. An adhesive 221 is applied to secure the second connector 213 to the body portion 211, and preferably coats the leg 216 and loop 217. The second connector 213 preferably may be formed with a leg with holding means also having a loop. The device 210 preferably is constructed and may be used in accordance with the embodiment of the device 10 described herein and shown in FIGS. 1-5.

In a third preferred embodiment, an orthodontic device 310 is illustrated in FIG. 7. The device 310 preferably is similar to the device 10, having a resilient body portion (not shown) and a first connector 312 with a leg 316 and a hook 314. The leg 316 is provided with an outer uneven surface 317. Preferably, as illustrated in FIG. 7, the outer surface 317 of the leg 316 has a plurality of cross cuts 325 formed therein. The second connector (not shown) preferably may be formed with a leg which also has an uneven surface. The leg 316 is attached to a body portion with an adhesive. The device 310 preferably is constructed and may be used as in accordance with the embodiment of the device 10 described herein and shown in FIGS. 1-6.

Referring to FIGS. 8 and 9, another preferred embodiment of the present invention comprises an orthodontic device 410 with an elastomeric body portion 411, and having a first connector 412 with a hook 420. The first connector 412 preferably may be constructed and attached to the elastomeric body portion in the same manner as the first connectors 12, 212, and/or 312 shown and described herein. The second connector 413 comprises a split tube 414 having a leg 416. The leg 416 preferably has holding means and is preferably connected to the body portion 411 with adhesive. The holding means, for example, may comprise raised bumps, a loop or an uneven surface portion such as for example a cross cut, or a combination of thereof. The split tube 414 facilitates connection of the orthodontic device 410 to an archwire. The split tube 414 has a lateral opening 415 disposed therein, and an interior space 417. The second connector 413 of the device 410 may be installed on an archwire by placing the split tube lateral opening over the wire and positioning the tube 414 so the archwire is in the interior space 417. The tube 414 may then be crimped to engage the archwire. The first connector 412 preferably is connected to another suitable structure, such as, for example, a receiving hook of a bracket, by crimping the hook 420 of the first connector 412.

The composition used for the elastomeric material preferably is an elastomer which is durable and may be adherable to a wire element. According to preferred embodiments, thermoplastic elastomers (TPE's) are used. One example of thermoplastic elastomers (TPE's) useful to form the elastomeric member may be those block copolymer types, including TPE's of styrene-ethylene/butylene-styrene block copolymers. The material possesses rubber-like characteristics but at temperatures above the melting point, melts and is flowable. The elastomeric material, when flowable, such as the TPE's, may be formed into a desired shape, and permitted to cool to the elongated configuration of the tensioning device.

A retaining element applied to the end of the wire member facilitates retention of the tensioning device assembly. A retaining element is provided in the preferred embodiments, and preferably is formed from a material which is rigid and onto which the elastomeric material, such as, for example a TPE, may be attached. According to the preferred embodiments, the elastomeric material is attached to the retaining element through a molding process.

The retaining element preferably is compatible with the elastomeric material so that there is suitable bond strength so that the bond may be sustained during tensioning conditions that the tensioning device is to repeatedly encounter when in use in a patients' mouth. Examples of compounds that may be used to form the retaining element include rigid materials, such as, polypropylene (PP), polyethylene (PE), amorphous polar plastics such as polycarbonate (PC), polymethylmethacrylate (PMMA), polystyrene (PS), high impact polystyrene (HIPS), polyphenylene oxide (PPO), glycol modified polyethylene terephthalate (PETG), acrylonitrile butadiene styrene (ABS), semicrystalline polar plastics such as polyester (PET, PBT) and polyamide (Nylon 6, Nylon 66). Preferably, the material, such as, for example, a TPE, used for the elastomeric member and the material used for the retaining element are provided to be compatible to afford the retention of the tensioning device components. The retaining element and the elastomeric portion of the tensioning device are secured together so the wire which has an end carrying the retaining element also is secured at that end to the elastomeric member. For example, the elastomeric material and the retaining element material may be formed for connection with a first connector, such as the steel wire, using molding steps, including for example two-shot molding or insert molding. According to preferred embodiments, the elastomeric body of the tensioning device may be constructed from a composition of an ESTANE® material (Lubrizol). According to preferred embodiments, the retaining element may be formed from a composition of an ISOPLAST® material (Lubrizol).

### Example 1

An orthodontic tensioning device was constructed using a 0.020 mm diameter stainless steel wire (outer diameter, o.d.=0.020 mm). The length of the wire was approximately 12 mm. The wire was bent at one end thereof to form a kink or loop. To the wire end where the loop was formed, a plastic material was installed thereon. The plastic material was applied by placing the wire in a mold and flowing molten plastic into the mold and onto the wire end. After the molten plastic cooled, the wire end contained a secure plastic element. A second wire was prepared and treated with a plastic element in the same manner as the first wire. Next, the treated wires were attached to an elastomeric member. The elastomeric member, in this example, was a latex composition and was molded onto each wire by molding over the treated end of the wire. The latex composition was formed from a thermoplastic elastomer compound based on styrene-ethylene/butylene-styrene block copolymer, and is commercially available from a number of manufacturers, including one TPE sold under the name UNISOFT TPE. One particular elastomeric TPE used in this Example has the following mechanical properties (see Table 1):

TABLE 1

| Mechanical Properties | Test Method | English-Units | SI-Units |
|---|---|---|---|
| Shore Hardness | ASTM D-2240 | 29 A | 29 A |
| Specific Gravity | ASTM D-792 | 0.93 (g/cc) | 0.93 (g/cc) |
| Tensile Strength | ASTM D-412 | 850 (psi) | 5.9 (Mpa) |
| Elongation at Break | ASTM D-412 | 650 (%) | 650 (%) |
| Compression Set | ASTM D 395 B | 10 (%) | 10 (%) |
| 22 hrs@RT | | | |

The thermoplastic elastomer was heated to about 310 to 410 degrees F. and was flowable. The mold may be heated, or preheated to facilitate flow of the TPE.

The latex elastomeric member was constructed to be about 4 to 5 mm (measured at its outer diameter (o.d.), and was elongate. The elastomeric member was formed by placing the treated wire ends on opposite locations of a mold for molding the latex elongated member. Each treated wire end was placed at an end of the mold so that the latex elongate member would attach to the treated wire ends at each end thereof. The device formed was strong and water and saliva resistant, and exhibited resiliency when stretched.

FIG. 10 illustrates a schematic diagram showing a preferred embodiment of the molding steps used to form a tensioning device according to the invention. Accordingly, the molding may be accomplished by techniques, such as, for example multi-component injection molding of the elastomeric member and the retaining member, overmolding or insert type molding.

FIG. 11 shows a sectional view of a preferred embodiment of a tensioning device 510 formed according to the present invention. The tensioning device 510 has a resilient body portion 511 with a first connector 512 and a second connector 513. Retaining elements 520, 521, respectively, are provided on the first connector 512 and second connector 513. The first connector 512 is illustrated having an end configuration which is illustrated in a preferred embodiment as a loop 522.

The resilient body portion 511 preferably carries the first connector 512 at one end thereof and the second connector 513 at the other end thereof. The first connector 512 and retaining element 520 are secured to the resilient body portion 511. The first connector 512 has means for attaching the first connector 512 to an orthodontic appliance. The second connector 513 is secured to the resilient body portion 511 and also has means for attaching the second connector 513 to an orthodontic appliance. The attachment means preferably may comprise a preformed end configuration or alternately, or in addition, may be a crimpable first connector 512. The second connector 513 may be similarly configured for connection with an orthodontic appliance.

FIGS. 11a through 11g, 11h through 11j, and 11l though 11p, illustrate further embodiments of the tensioning device shown in FIG. 11. According to the illustrations, a preferred exemplary embodiment is shown with examples of preferred dimensions for the tensioning device. Though the wire ends are illustrated in a preferred configuration having an open hook portion that is surrounded by a retaining element, the wire hook end may be alternately configured such as for example as a ring, or bar, so that the wire portion of the device may be suitably held by the retaining element. Though preferred dimensions are provided, the tensioning device according to the invention may be constructed with dimensions other than those shown and referred to in FIGS. 11a through 11g, 11h through 11j, and 11l through p.

According to the preferred embodiments of the process, a tensioning device may be produced by providing the first wire member and second wire member, which for example may be steel wires that are crimpable. On an end of each wire segment, a retaining element is formed to leave at least a portion of the wire segment uncovered. The process includes forming a connecting structure between the first wire member and the second wire member. The connecting structure forms a resilient body portion. The connecting structure preferably is formed over the retaining element. This may be done by a first step wherein the retaining element is formed on the wire prior to the installation of the connecting structure, or alternately, the retaining elements and connecting structure may be formed together. The resultant device includes the connecting structure that forms a resilient body portion with wire ends projecting from each end thereof. The retaining element may be surrounded by the connecting structure in totality or in substantial part so as to secure the wire members and the connecting structure together. The process may be used to produce the embodiments of the tensioning devices illustrated in FIGS. 11, 11a-11g, 11h-11j, 11l-11p, 12, 13, as well as those shown in FIGS. 14-16.

FIGS. 14, 15 and 16 show examples of orthodontic tensioning devices which include wire end connecting portions attached to an elastomeric body. Though measurements of the devices may be of various sizes to accommodate various patients and tensions, examples of some preferred dimensions are illustrated in FIGS. 14 and 15. For example, one preferred length of the elastomeric body may be about 1.66 inches.

According to FIG. 17, there is illustrated a preferred embodiment of an orthodontic tensioning device 610 that includes a resilient body portion 611 with a first connector 612 and a second connector 613. The resilient body portion 611 preferably carries the first connector 612 at one end thereof and the second connector 613 at the other end thereof. According to a preferred embodiment, the first connector 612 and the second connector 613 may be identical connectors, but they do not have to be. The first connector 612 is mounted on the resilient body portion 611 and has means for attaching the first connector 612 to an orthodontic appliance. The second connector 613 is mounted to the resilient body portion 611 and has means for attaching the second connector 613 to an orthodontic appliance. Preferably, the resilient body portion 611 is comprised of a material which is not readily prone to corrosion when exposed to the environment of a patient's mouth. The resilient body portion 611 may be comprised of other orally suitable elastomers, such as natural and synthetic rubbers, thermoplastic elastomers, and blends of these materials, including any of those elastomeric materials described herein. Examples of preferred materials include those selected from the group of materials including: SBC's (styrene-block-copolymers), such as, SEBS (styrene ethylbutylene styrene), SEPS (styrene ethylene propylene styrene), SBS (styrene butadiene styrene), SIS (styrene isoprene styrene), and EPDM (ethylene-propylene-diene-monomer), thermoplastic polyurethane, cross linked polyurethane, silicone, natural rubber, and copolyester.

The first connector 612 and a second connector 613 may be configured to facilitate mounting of the device 610 onto an orthodontic structure, such as, for example, a pin 300 of a bracket 301. The first connector 612 is shown having a bore 615 therethrough that is preferably dimensioned to receive the bracket pin 300 therethrough. As illustrated in FIG. 17, the bore 615 preferably includes a first bore portion 616 and a second bore portion 617. According to a preferred configuration, the first bore portion 616 preferably has a length that will permit the head 302 of the pin 300 to pass through when the device 610 is installed on a bracket 301. The bore 615 is illustrated having a second bore portion 617 that has a larger dimension, which may, for example, be a larger width or diameter, than the first bore portion 616. The second bore portion 617 is shown configured to receive the pin head 302 of the bracket pin 300. An example of a bracket 301 and pin 300 is shown in FIG. 20.

The first connector 612 preferably may be constructed from a suitable material which is durable and resistant to moisture and the conditions present in a human mouth. According to a preferred embodiment, the first connector 612 has a key, such as, for example, the circumferential flange 620, which is configured to connect with the mounting end 621 of the device 610. The first mounting end 621 preferably is constructed having an aperture 622 disposed therein that includes a wider portion 623 that is designed to receive the flange 620 of the first connector 612. Preferably, a press-fit mounting may be used to install the first connector 612 on the resilient body portion 611, and in particular on the first mounting end 621. The first connector 612 preferably is constructed from a material which is capable of engaging with an orthodontic structure, such as, for example, the bracket pin 300. According to preferred embodiments, the first connector 612 may comprise a grommet which may be constructed from an acrylic or metal so as to provide durability to the device 610 when the device 610 attached to orthodontic hardware structures and when the device 610 is in use where it is subjected to forces from stretching.

The second connector 613 may be constructed and attached to the second mounting end 631 of the device 610 in the same manner as described in connection with the first connector 612. The second mounting end 631 may be configured the same as that shown and described in connection with the first mounting end 621, and the second connector 613 may be constructed as described herein in connection with the first connector 612.

FIG. 18 illustrates a top plan view of the tensioning device 610 shown in an uninstalled condition, where the ends are not connected to the bracket 301. FIG. 19 illustrates the first connector 612 in an exploded separate sectional view that shows the first connector 612 separate from the elastomeric body portion 611 and the second connector 613. The connector flange 620 of the first connector 612 preferably is configured to facilitate mounting in the first mounting end 621 of the elastomeric body portion 611.

FIGS. 17a through 17g illustrate alternate views of the tensioning device 610 and bracket 301 and shown in FIGS. 17-20. An exemplary proposed force profile for a stretching condition is represented by the graphs in FIGS. 17i and 17j, with respective illustrations shown in FIGS. 17h and 17k.

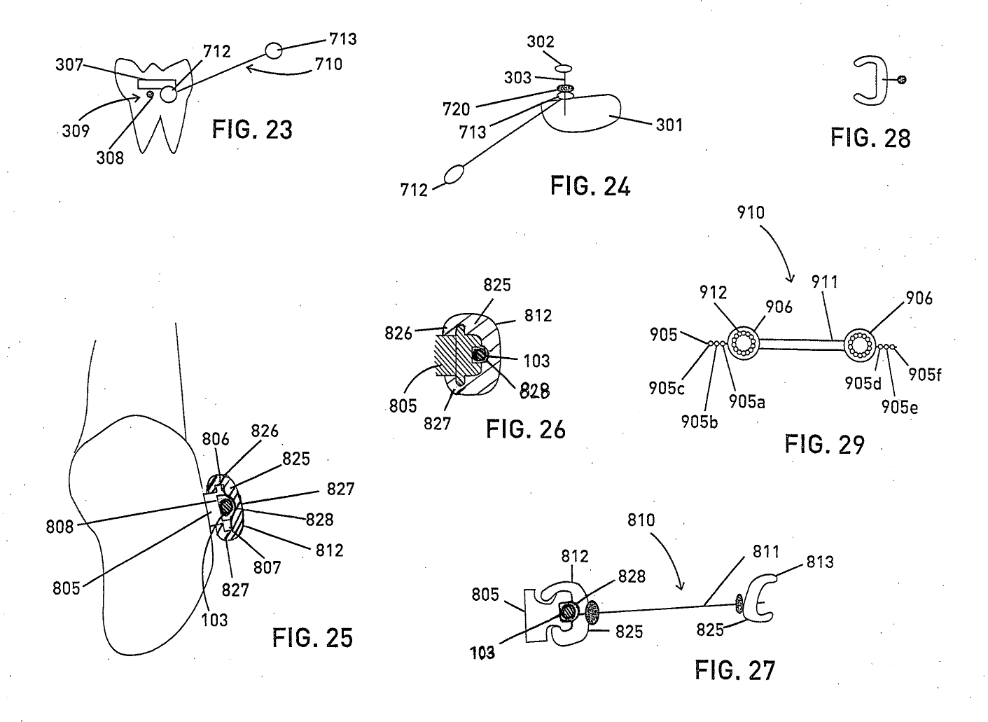

Referring to FIGS. 21-24, there is illustrated an alternate embodiment of an orthodontic tensioning device 710 which includes an elastomeric body portion 711a first connecting end portion 712 and a second connecting end portion 713. The first connecting end portion 712 preferably is formed with an aperture 714 therein that is configured to be positioned on a bracket. For example, according to a preferred installation, the device 710 may be installed on the pin 300 of a bracket 301 by sliding the first connecting end portion 712 over the pin 300 so that the aperture 714 is positioned on the pin shaft 303. For example, as shown in FIG. 23, the device 710 is illustrated connected to a hook 306 of a molar tube 307, the hook 306 having a shaft 308 and head 309, the molar tube 307 being secured on a molar 305. According to a preferred embodiment, the second connecting end portion 713 of the device 710 may be configured the same as the first connecting end portion 712, with an aperture 716. According to a preferred installation, a retaining element, such as, for example, a split washer 720, shown in FIG. 24, may be used to secure the first connecting end portion 712 to the bracket pin 300. Other suitable retaining elements may be used, such as split rings and the like. The split washer 720 may be installed by placing it on the pin shaft 303 in a location above the first connecting end portion 712 and then configuring the split washer 720 by crimping it or shaping it to a position or configuration where it is secured on the pin 300. For example, preferably, the pin head 302 acts as a stop relative to the split washer 720, so that once the split washer 720 is secured on the pin shaft 303, it does not slip past the pin head 302. The removal of the device 710 may be accomplished by expanding the split washer 720 and then removing the split washer 720 and removing the connecting end portion 712 from the pin 300.

Referring to FIGS. 25-28, there is illustrated an alternate embodiment of a tensioning device 810 which includes an elastomeric body portion 811a first connecting end portion 812 and a second connecting end portion 813. The first connecting end portion 812 preferably is formed with a retaining element shown comprising a cap 825 that is configured to be mounted onto a bracket, such as, for example, the bracket 805. The bracket 805 is illustrated comprising an upper flange 806 and a lower flange 807 and has a groove therein 808 for receiving an archwire 103′. The cap 825 preferably is configured having a first or upper flange 826 and a second or lower flange 826 that connect with the cap structure 827. The cap structure 827 preferably includes a groove 828 provided therein so that when the tensioning device 810 is installed on a bracket 805 and press fit onto the bracket upper and lower flanges 806, 807, an archwire that may be present (which, for example, may be passing through the bracket groove 808) may be accommodated.

As illustrated in FIGS. 25-27, the archwire 103′ is shown in a sectional view passing through the bracket groove 308. The cap 825 of the tensioning device 810 preferably is constructed so that it may be installed on the bracket flanges 806, 807 and may be retained thereby without interfering with the archwire 103′. According to a preferred configuration, the cap element 825 of the device 810 may include a groove 828 which is illustrated receiving the archwire 103′. For example, according to a preferred installation, the device 810 may be installed on the bracket 805 by aligning one of the connecting end portions 812, 813 over the bracket flanges 806, 807, and pressing the connecting end 812, 813 onto the bracket 805 so that the retaining cap 825 securingly engages with the bracket flanges 806, 807. Similarly, removal of the device 810 may be accomplished by exerting a pressure on the end portion 812 of the device 810 to maneuver the cap 825 so that it may be disengaged from the bracket 805.

According to a preferred embodiment, the device 810 may be constructed by the methods disclosed herein, including the molding method, where the retaining cap 825 is molded with the elastomeric body 811 (FIG. 27) so that the end portion 812 of the device 810 is formed with the cap 825 held thereby. In addition, an alternate method is to provide a retaining cap 825 having a flanged configuration similar to the configuration disclosed herein for example in FIGS. 17-20 where the first connector 612 is secured at the elastomeric first end portion 621. The device 810 may be constructed having an end portion 812 with an aperture therein that may receive and secure a cap element 825. For example, as with the device 610, the tensioning device 810 may be constructed so that it has a mating configuration at the end portion 812 that is dimensioned to receive a flange (not shown) or other retaining portion of the cap element 825.

As shown in FIG. 27, with a retaining cap 825 provided at each end of the elastomeric body 811, the tensioning device 810 may be installed by pressing the end of the device 10 onto a bracket, such as the bracket 805 shown and described. In addition, alternate embodiments may be constructed where the tensioning device 810 includes at least one retaining cap 825 at one end thereof and has an alternate securing element at the other end, such as, for example, a crimpable member or wire, or any other suitable connecting mechanisms, including any of those described herein. The retaining cap 825 portion of the device 810, preferably, is constructed from a material, e.g., plastic, steel or other suitable material, that can be sturdy yet resilient so as to allow a press fit installation onto the bracket flanges 806, 807.

An alternate embodiment of an orthodontic tensioning device 910 is shown in FIG. 29. Preferably, the device 910 is constructed from an elastomeric material, such as, for example, those discussed herein, and includes a plurality of engaging elements 905, 906 that may be positioned to engage an orthodontic appliance, such as, for example, the pin of a bracket or hook on a molar band. The device 910 may be attached to structures used for orthodontic treatments, and particularly, those structures installed in the mouth of a patient, such as brackets, bands and the like. According to a preferred configuration, the engaging elements 905, 906 are provided to include a plurality of outer engaging elements 905a, 905b, 905c, 905d, 905e, 905f and a plurality of inner engaging elements 906. The outer engaging elements 905 may be linked together, for example, with a plurality of elements 905 forming a linkage of a suitable length. The linkage length, for example, formed from the outer engaging elements 905a, 905b, 905c may be adjusted by cutting or removing links or elements 905 to form linkages of different lengths. Though, in the exemplary embodiment shown in FIG. 29, three outer engaging elements 905 are shown on each end of the device 910, other numbers and configurations of engaging elements may be linked together (or removed therefrom) to form longer or shorter lengths.

The engaging elements 905, 906 preferably are retained on the elastomeric body portion 911 of the device 910. The engaging elements 905 and 906 may be held on the elastomeric body portion 911 with a suitable mounting means or method, such as, for example, by forming the elastomeric body 911 over the engaging elements 905, 906, or by providing a mounting flange or flanges (not shown) on the engaging elements 905, 906 that are designed to be held by the elastomeric material of the body 911. In addition, or alternately, a suitable retaining component may be used to attach the engaging elements 905, 906 to the elastomeric material. According to a preferred embodiment, the engaging elements 905, 906 may be attached using the overmolding method or compositions, or both, described herein. For example, the engaging elements 905, 906 may be secured to the elastomeric end portions 912, 913 using a retaining element such as those 520, 521 shown and described in connection with the embodiment of FIG. 11, and those shown in FIGS. 11c through 11f. Preferably, the engaging element 905a proximate to the elastomeric first end 912 may be secured to the elastomeric body portion 911 of the device 910, and the additional engaging elements 905b, 905c, may be attached through their respective linkages. In addition, though the inner engaging elements 906 are shown disposed over the elastomeric end portion 912, this represents one preferred arrangement, with another preferred arrangement being providing the inner engaging elements 906 within the elastomeric portion, so they are not as visible and may be protected. The engaging elements 905, 906 preferably are crimpable so that they may be attached to a structure, such as a hook or pin of a bracket or band, and may be crimped to secure thereto.

The engaging elements 905, 906 may be constructed from a suitable composition, such as metal (e.g., stainless steel). Though not shown, the device 910 may be constructed with alternate configurations for the engaging elements, such as, for example, a molded component, such as, nylon or other suitable durable and flexible material that may be formed to include linkages that may be cut or removed to adjust the length of the device.

According to preferred embodiments, the tensioning devices according to the invention may be constructed to have a desirable force tension so that a desired force may be provided for treatment when the device is installed in a patient. When the tensioning device is installed, it is designed to provide a force to facilitate treatment of an orthodontic condition. For example, some preferred force levels for the tensioning devices may be 100, 200 and 300 grams of force. Considering an application in a patient, for example, a tensioning device may be installed at the hook on the cuspid and stretch to a molar hook, where when installed, the tensioning device preferably is stretched from its original length or condition to a stretched length or condition. The strength of force for the stretching, according to preferred embodiments, may range between from about several grams up to a few hundred grams of force, with preferred force levels being from about 100 to 300 grams. The tensioning devices according to the invention may be provided in different lengths so that a suitable tensioning device can be used for patients according to that patient's physiology and needs, so that the patient's need is matched to a desired force characteristic.

Preferred embodiments of the tensioning devices according to the invention may regulate the elastomeric composition by controlling the components of the elastomer composition and/or the process for forming the elastomeric portion of the tensioning device to provide different force levels, such as, for example, by providing different levels of stretchability to the elastomeric component of the tensioning device. Therefore, according to some preferred embodiments, tensioning devices may be provided in a kit with differing force characteristics so that a tensioning device that is desired for a particular patient may be selected for use.

Various modifications may be made within the spirit and scope of the invention. For example, though the embodiments illustrated in the figures, including the exemplary embodiments of FIGS. 11-16 show crimpable end portions, a track end portion, such as that shown in FIG. 8 may be used. Alternately, a retaining cap may be used as a connector for connecting one or both ends of the tensioning device to a bracket flange. Connectors may comprise wire lengths which may be cut and crimped as required. In addition, as illustrated in FIGS. 14, 15 and 16, the elastomeric material may be provided in different lengths and thicknesses to accommodate different needs of tension. The devices illustrated and described herein may be used with intraarch applications, such as, for example, from a molar hook to a hook on the cuspid bracket of the same dental arch. Although the invention is described in relation to several embodiments, various modifications and changes may occur to those skilled in the art without departing from the spirit and scope of the invention described herein and as defined by the appended claims.

1. (canceled)

2. The device of claim 1, having a first connector and a second connector, said first connector and said second connector being separated by a resilient body portion and attached to said resilient body portion.

3. The device of claim 2, wherein at least one of the first connector and the second connector comprises a member adapted for securing to an orthodontic appliance.

4. The device of claim 2, wherein said first connector is deformable.

5. The device of claim 2, wherein said member is crimpable.

6. (canceled)

7. (canceled)

8. The device of claim 2, wherein said first connector has mounting means for mounting the first connector to said body portion.

9. The device of claim 8, wherein said second connector has mounting means for mounting the second connector to said body portion.

10. The device of claim 2, wherein said first connector has mounting means for mounting the first connector to said body portion.

11-18. (canceled)

19. An orthodontic device having a resilient body portion with two ends, wherein each is adapted for connection with an orthodontic member, a first connector and a second connector, the first connector and the second connector being separated by the resilient body portion and each being fixedly attached to said resilient body portion, the first connector being adapted for securing to an orthodontic appliance, and the second connector being adapted for securing to an orthodontic appliance, said first connector and said second connector having a crimpable element thereon for attachment to an orthodontic component.

20. The device of claim 19, wherein retaining elements are provided, there being a first retaining member that attaches with said first connector and with said resilient body portion, and there being a second retaining member that attaches with said second connecting member and said resilient body portion.

21. An orthodontic device having a resilient body portion with two engageable ends, wherein each said engageable end is adapted for connection with an orthodontic member, and wherein each said engageable end is attached to said resilient body portion, each said engageable end comprising at least a connecting portion configured to connect with said resilient body portion, and retaining means for retaining said connecting portion of each said engageable able end with said resilient body.

22. The device of claim 21, wherein said retaining means comprises a retaining element provided on said connecting portion of said engageable end.

23-40. (canceled)

41. An orthodontic device having a resilient body portion with two ends, wherein each end is adapted for connection with an orthodontic member.

42. The device of claim 41, having a first connecting portion provided at one of said two ends and a second connecting portion provided at the other of said two ends, wherein said first connecting portion and said second connecting potion each comprises a member adapted for securing to an orthodontic appliance.

43. The device of claim 42, wherein at least one of said connecting portion member is configured for attachment to a bracket.

44. The device of claim 43, wherein the at least one connector is configured to attach to a pin of a bracket.

45. The device of claim 43, wherein the at least one connector is configured to attach to a flange of a bracket.

46. The device of claim 45, wherein said connecting portion comprises a retaining element that has flanges for connecting with the flanges of a bracket.

47. The device of claim 41, including a retaining element that is configured to be installed to secure the end of said device to a bracket.

48-49. (canceled)

50. The device of claim 41, comprising engaging elements at each end thereof.

51. The device of claim 50, wherein said engaging elements are adjustably provided.

52. (canceled)
